(19) United States
(12) Patent Application Publication
(10) Pub. No.: US 2007/0291126 A1
(43) Pub. Date: Dec. 20, 2007

(54) CAMERA WITH INTERCHANGEABLE LENSES HAVING ELECTRICAL CIRCUITRY

(75) Inventors: Seiki MORISHITA, Osaka (JP); Masahiro NAKADA, Osaka (JP); Tetsuya MORI, Osaka (JP); Junko HAYASHI, Osaka (JP)

Correspondence Address: MARK D. SARALINO (MEI);RENNER, OTTO, BOISSELLE & SKLAR, LLP, 1621 EUCLID AVENUE, 19TH FLOOR, CLEVELAND, OH, 44115, US

(73) Assignee: MATSUSHITA ELECTRIC INDUSTRIAL CO., LTD., Osaka (JP)

(21) Appl. No.: 11/765,474

(22) Filed: Jun. 20, 2007

(30) Foreign Application Priority Data
Jun. 20, 2006 (JP) 2006-170041

(51) Int. Cl. H04N 5/225

(52) U.S. Cl. 348/207.99

(57) ABSTRACT

There is provided an interchangeable lens type camera which is so safe as to prevent spread of fire when dust strays into the interior of the camera to cause heating and/or electrical leakage of the electric circuitry and invite ignition. The camera includes a case having a mount section for mounting a detachable lens; electric circuitry provided within the case; and a member covering at least a portion of the electric circuitry to prevent the electric circuitry from being exposed to the exterior when the lens is detached from the mount section.

### BACKGROUND OF THE INVENTION

1. Field of the Invention

The present invention relates to a camera having electric/electronic circuitry. More particularly, the present invention relates to a digital camera with an interchangeable lens, in which countermeasures against heating and/or electrical leakage are taken for internal electric/electronic circuitry.

2. Description of the Related Art

Cameras have conventionally been widely prevalent as products which image subjects by operating mechanical structures such as shutters. Traditional cameras were only equipped with mechanical structures, and it is in the recent years that electric/electronic circuitry (hereinafter collectively referred to as “electric circuitry”) has come to be internalized for effecting various control.

In particular, the recording medium for subjects has conventionally been a film, but semiconductor memory has begun to be used in the recent years. Such cameras are widely known as digital cameras. In a digital camera, a subject is imaged by using electronic circuitry such as a CCD, whereby digital data is generated. The digital data is recorded to semiconductor memory. For such processing, a large amount of electric/electronic circuitry is internalized in a digital camera.

Electric power is needed for executing various functions on a digital camera, and therefore the electric power used is on the increase. For example, Japanese Laid-Open Patent Publication No. 8-313952 refers to a handshake correction function of a digital camera. A handshake correction function is a function for, by detecting handshake with a gyro and moving certain lens(es) in accordance with the amount of blur, obtaining an image of a subject that is hardly influenced by handshake. The motor or the like for moving the gyro and the lenses requires a large electric power.

Since cameras consume a large electric power, safety measures are needed against heat generation and other phenomena caused by their electric circuitry. For example, Japanese Laid-Open Utility Model Publication No. 62-2039 discloses a technique of providing an alarm indication when a battery is inserted in the wrong direction. Japanese Laid-Open Patent Publication No. 55-142323 discloses a technique of preventing burnout by using a flame retarder for a focal plane shutter. Moreover, Japanese Laid-Open Utility Model Publication No. 1-19925 discloses a technique of compulsorily turning OFF a power switch, which occurs when the power switch is caught by a cover into which the camera main body is accommodated.

In a small-sized digital camera in which a main body and lenses are integrated, i.e., a so-called digital compact camera, the joints and the like of the housing are sealed during assembly. As a result, foreign bodies such as dust are prevented from intruding into the interior of the main body. Furthermore, by producing the main body itself with a metallic or flame-retardant material, it becomes possible to lower the possibility of ignition even when the interior circuitry becomes heated. Moreover, since users will not touch the interior of the housing with their hands, there is no fear of electrification. Therefore, it can be said that the housing already provides sufficient safety measures.

However, in the case of an interchangeable lens type camera that allows the lens to be separated from the main body, when the lens is detached, the lens mount section on the main body forms an aperture (opening) in the main body. Since the internal electric circuitry is exposed to the exterior via the lens mount section, combustible foreign bodies, such as dust, are likely to enter.

The power consumption of digital cameras is increasing, and an electric current as large as several A (ampere) may flow in the wiring of the printed circuit board. If a straying foreign body becomes attached to the wiring or a device which consumes a large electric power on the printed circuit board within the main body, the electric circuitry may be heated to a high temperature. Electrical leakage may also occur.

Furthermore, in order to clean inside the housing, the user may insert his or her finger into the interior of the main body, via the lens mount section of the main body.

Under such situations, ignition inside the camera or camera malfunctioning may occur due to heating and/or electrical leakage, thus allowing the user to be injured.

### SUMMARY OF THE INVENTION

An object of the present invention is to provide an interchangeable lens type camera which is so safe as to prevent spread of fire when dust strays into the interior of the camera to cause heating and/or electrical leakage of the electric circuitry and invite ignition.

A camera according to the present invention comprises: a case having a mount section for mounting a detachable lens; electric circuitry provided within the case; and a member covering at least a portion of the electric circuitry to prevent the electric circuitry from being exposed to the exterior when the lens is detached from the mount section.

The member may be composed of a flame-retardant material.

The electric circuitry may be enclosed by the member.

The electric circuitry may be provided on a board which is composed of a flame-retardant material, and the electric circuitry may be covered by the member.

The electric circuitry may include a plurality of circuits, such that at least one first circuit among the plurality of circuits is covered by the member, and at least one second circuit among the plurality of circuits is not covered by the member.

The plurality of circuits may be classified into either the first circuit or the second circuit depending on a level of used voltage or consumed electric power.

The electric circuitry may be a power supply circuit.

The electric circuitry may include a booster circuit for generating flashlight; and the booster circuit may be enclosed by the member.

The electric circuitry may be enclosed by a plurality of said members.

The electric circuitry consuming an electric power of 15 watts or more may be enclosed by the member.

The camera may further comprise a component, at least one portion of outer surface thereof is composed of a flame-retardant material, wherein, the at least one portion of the outer surface may cover at least a portion of the electric circuitry.

The camera may further comprise a battery box for accommodating a battery, the battery box having a first terminal for allowing electric power from the battery to be supplied to the exterior of the battery box, wherein, a second terminal which is in electrical connection with the electric circuitry may be provided on the member covering at least a portion of the electric circuitry, the second terminal being in contact with the first terminal.

A camera according to the present invention comprises: a case having a mount section for mounting a detachable lens; electric circuitry provided within the case; and a member enclosing at least a portion of the electric circuitry, the member being composed of a flame-retardant material.

According to the present invention, component parts, circuits, and wiring which transmit or consume a large electric power are enclosed by flame-retardant members, thus providing an effect of preventing spread of fire in the event of an ignition which is caused by the interior of the housing being abnormally heated or by electrical leakage.

### BRIEF DESCRIPTION OF THE DRAWINGS

FIG. 1 is a diagram schematically showing the exterior appearance of an interchangeable lens type camera 1 according to Embodiment 1.

FIG. 2 is a diagram showing the construction of a subenclosure 18.

FIG. 3(a) is a diagram showing permissible gaps A1 to A3 which are provided in a subenclosure 18; and FIG. 3(b) is a diagram showing a cross section of the subenclosure 18 having the gap A3.

FIG. 4 is a diagram showing a printed circuit board 20 to be enclosed by the subenclosure 18.

FIG. 5 is a diagram showing a cross section of the subenclosure 18.

FIG. 6 is a diagram showing an example where one face of the printed circuit board 20 on which no circuit elements exist constitutes part of the subenclosure 18.

FIG. 7 is a diagram showing interconnections between the subenclosure 18 and a battery pack 50 which is a power supplying source.

FIG. 8 is a diagram showing relative positioning of a battery box 16, the battery pack 50, and the subenclosure 18 within a housing 12.

FIG. 9 is a diagram schematically showing the exterior appearance of a camera 2 according to Embodiment 2.

FIG. 10 is a diagram showing relative positioning of an aluminum frame 60, a battery box 16, and a printed circuit board 20.

FIG. 11 is a diagram more clearly showing the relationship between the battery box 16, the battery pack 50, and the printed circuit board 20 in FIG. 10.

FIG. 12 is a side cross-sectional view of the subenclosure 18 shown in FIG. 10.

FIG. 13 is a diagram showing a construction in which a memory holder 70 is placed between the printed circuit board 20 and the aluminum frame 60.

FIG. 14 is a side cross-sectional view of a subenclosure having the memory holder 70.

FIG. 15(a) is a diagram showing a circuit element 80 on a portion of the printed circuit board 20 enclosed by the subenclosure 18; and FIG. 15(b) is a cross-sectional view thereof.

### DETAILED DESCRIPTION OF PREFERRED EMBODIMENTS

Hereinafter, embodiments of the camera according to the present invention will be described with reference to the attached drawings.

As will be specifically described in each embodiment below, it is assumed that any camera that is described in the present specification is a camera which allows the lens to be detached therefrom, i.e., an interchangeable lens type camera.

One feature of the camera according to the present invention is that, in order to prevent electric circuitry which consumes a large electric power from being exposed to the exterior of the camera when the lens is detached from the camera, at least a portion of the electric circuitry is covered by a flame-retardant member such as a metal plate.

Herein, when electric circuitry is said to be “exposed to the exterior of the camera”, it is meant that, when a foreign body (e.g., dust) existing outside a housing (case) of the camera intrudes into the housing via an opening (mount section), the electric circuitry is reachable by that foreign body.

Also, in the present specification, to “cover” means to overlap wholly or partially.

Note that it is particularly preferable that the electric circuitry is substantially completely covered by a flame-retardant member because foreign bodies such as dust will never reach the electric circuitry. However, even if it is not completely covered, the objective of the present invention will be met under any construction in which the foreign bodies will not reach the electric circuitry because of its relationship with other interior structures (e.g., a battery box) of the camera. Therefore, any such construction is also encompassed by the present invention.

The aforementioned electric circuitry may be limited to electric circuitry whose power consumption is 15 watts or more, or electric circuitry using a voltage which is greater than a predetermined value. As such electric circuitry, a power supply circuit and a booster circuit for generating flashlight are envisaged, for example. Electric circuitry may also include the printed circuit board, wiring, and electrical devices (circuit elements), for example.

The camera described in each of the following embodiments may be any interchangeable lens type camera that includes electric circuitry. For example, it may be a so-called interchangeable lens type digital camera, which records image information onto a memory card or a hard disk by using an imaging device such as a CCD or a CMOS. Furthermore, any interchangeable lens type camera that utilizes a film as a recording medium is also encompassed within the camera according to each embodiment, so long as it includes electric circuitry.

### Embodiment 1

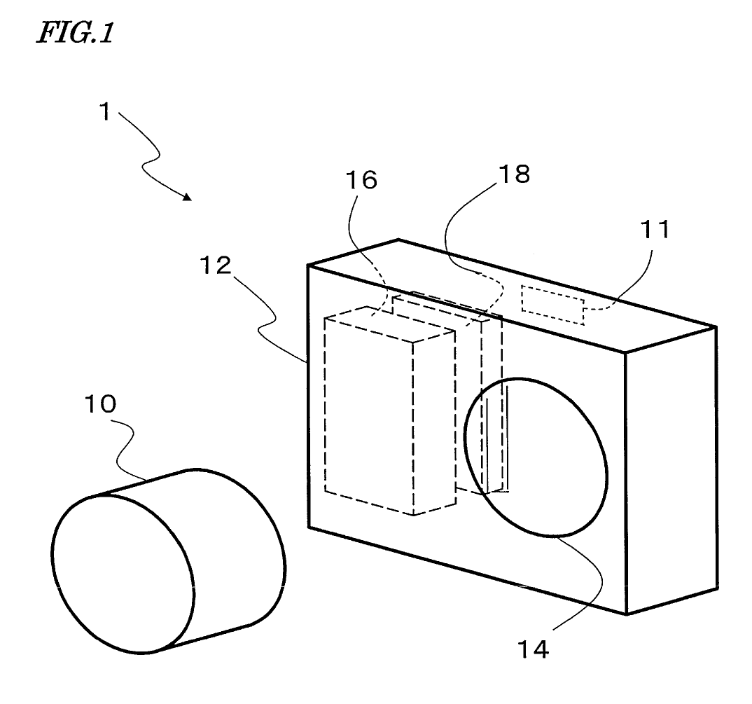

FIG. 1 schematically shows the exterior appearance of an interchangeable lens type camera 1 according to the present embodiment, which allows a lens 10 to be attached to or detached from it.

The interchangeable lens type camera 1 hereinafter referred to as the “camera 1”) mainly includes a lens 10 and a camera housing (camera case) 12. The lens 10 is fixed to a mount section 14 which is provided in the camera housing 12.

When the lens 10 is detached from the mount section 14, the interior of the camera housing 12 is exposed to the exterior. External light (subject image) travels through the lens 10 to enter the camera housing 12, and enters an imaging device (not shown). Thus, the subject can be imaged by using the camera 1.

At the left-hand side of the interior of the camera housing 12, as the camera 1 is viewed from the side of the lens 10, a subenclosure 18 (specifically described later) and a battery box 16 in which a battery pack for the camera 1 is to be mounted are provided. Assuming that the face of the camera housing 12 on which the mount section 14 is provided is the front face, a finder 11 or a liquid crystal display is provided on the opposite face (rear face).

Note that, in the present specification, the “left-hand side” and “right-hand side” mean the leftward direction and rightward direction, respectively, as the camera 1 is viewed from the side of the lens 10. Moreover, when the camera housing 12 is placed on a horizontal surface, the height direction of the camera 1 off that horizontal surface will be defined as the “upper direction”, whereas the opposite direction of the “upper direction” will be referred to as the “lower direction”. The “lower direction” is the direction of a normal which heads toward the horizontal surface from the finder 11.

Next, the subenclosure 18 will be specifically described.

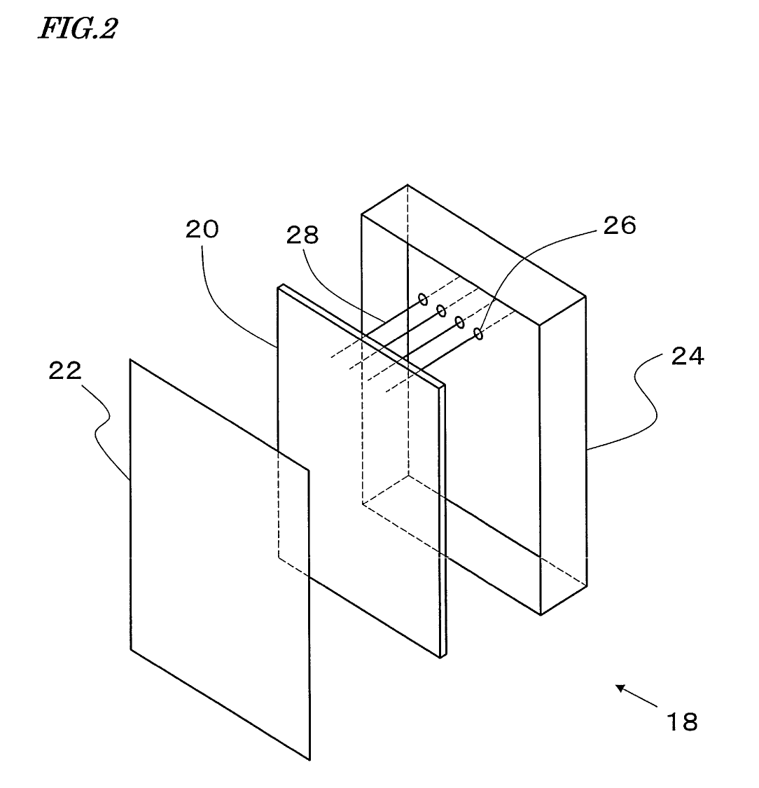

FIG. 2 shows the construction of the subenclosure 18. In the following descriptions, a printed circuit board 20 will be illustrated as an example of electric circuitry to be enclosed by the subenclosure 18.

The printed circuit board 20 is enclosed in all six directions by a flame-retardant member 22 and a flame-retardant member 24, which compose the subenclosure 18. In other words, the subenclosure 18 is composed of the flame-retardant members 22 and 24 which enclose the printed circuit board 20 in which a large electric current flows.

The subenclosure 18 is a structure that encloses electric circuitry which consumes a large electric power of 15 watts or more, for example. Because a power supply circuit and a booster circuit qualify for such electric circuitry, the subenclosure 18 is disposed near a battery or an adapter line which supplies electric power.

The reason for providing the subenclosure 18 is to, when the lens 10 is detached from the mount section 14, prevent the printed circuit board 20 from being exposed to the exterior. The printed circuit board 20, in which a large electric current flows, is enclosed by the subenclosure 18 that is formed of the flame-retardant members 22 and 24, and therefore dust intruding via the mount section 14 is prevented from adhering to the printed circuit board 20. As a result, damaging of the printed circuit board 20 due to overheating or combustion of such dust can be prevented.

As the flame retarder, known materials can be used. For example, bromine-type flame retarders and phosphorus-type flame retarders, which are plastic flame retarders, can be used. As bromine-type flame retarders, substitutes for decabromodiphenyl ether, such as TBBPA (tetrabromobisphenol A) and TBBPA epoxy oligomer, and HBCD (hexabromocyclododecane) are known, for example. As phosphorus-type flame retarders, those which are condensed phosphate-type are known, as well as antimony trioxide.

By mixing one or more of such materials in a plastic to serve as the base substance, the plastic is made immune from ignition, and difficult to burn. Among plastics, polyethylene, polypropylene, polysthyrene, ABS, polycarbonate, and many other polymer resin materials can be used as the substrate.

It is not easy to quantitatively evaluate how difficult a material is to burn. However, by taking the flammability classes from a flammability test that is defined by the UL standards for example, it would be desirable to use a material of the flammability class of V1. A V1-class material is defined as: (1) a material which may give a flame or glow in a test which is performed under predetermined conditions, but is extinguishable within 5 seconds on average; and (2) a material such that any burning matter falling therefrom does not allow surgical cotton to be ignited. Note that, among materials of the same V1 class, those materials having shorter extinction times will be preferable from the standpoint of difficulty to burn.

The flammability classes under the UL standards are defined as 5VA, 5VB, V0, V1, V2, and HB, in descending order of anti-flammability (i.e., from the more difficult to burn).

The same type of member or different types of members may be used for the flame-retardant members. For example, in FIG. 2, the flame-retardant member 22 and the flame-retardant member 24 may be produced from the same kind of material, or produced from different kinds of material.

Note that the flame-retardant members 22 and 24 are described as “enclosing” the printed circuit board 20 in the above description. In the present specification, to “enclose” means to contain the target electric circuitry within a closed space (i.e., three-dimensionally). The flame-retardant members 22 and 24 serve as the boundaries making this closed space. The closed space does not need to be cubic, but may be a polyhedron, or composed of smoothly curved surfaces. The polyhedron may be so shaped as to have a plurality of overlapping rectangular solids.

The aforementioned “closed space” is not limited to a completely closed space, but may have minute gaps. The reason is that, since the subenclosure 18 encloses the printed circuit board 20, which handles a large electric power, its interior temperature is likely to increase. If it is completely closed, the heat and moisture will have nowhere to go. Moreover, the wiring must be taken out from the interior.

As shown in FIG. 2, throughholes 26 penetrate through the flame-retardant member 24, such that four power IN/OUT terminals 28 which are provided on the printed circuit board 20 are taken out of the subenclosure 18 through the respective throughholes 26. From a battery pack (not shown) within the battery box 16, electric power is supplied to the printed circuit board 20 via the power IN/OUT terminals 28. Even if such throughholes 26 are provided, the printed circuit board 20 can still be said to be enclosed by the flame-retardant members.

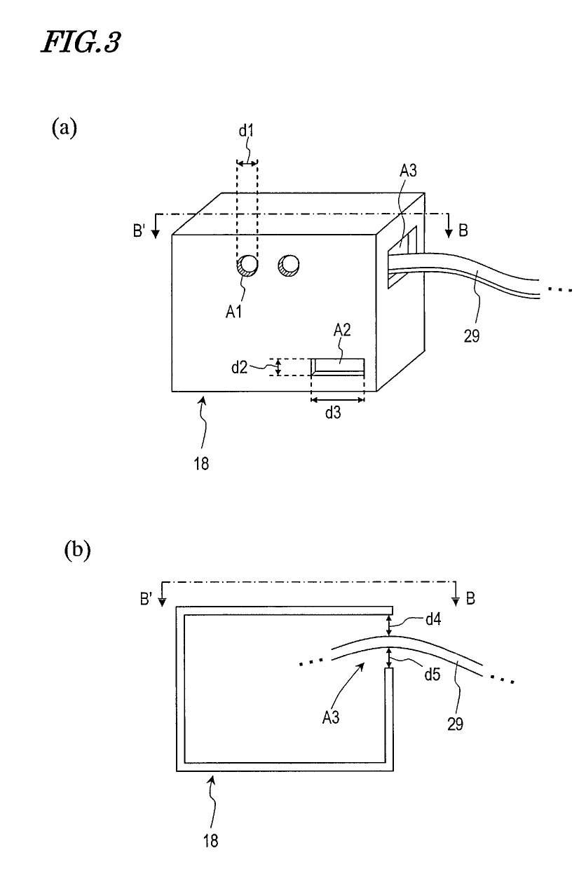

However, if the gaps are too open, the present invention's purpose of preventing ignition will be defeated. Therefore, with reference to FIG. 3, examples of gaps which comply with the notion of being “enclosing” according to the present invention will be described.

FIG. 3(a) shows permissible gaps A1 to A3 which are provided in the subenclosure 18. The circular-shaped gap A1 corresponds to the aforementioned throughhole. In the present embodiment, the gap A1 has a maximum diameter d1 of less than 1 mm.

The slit-like gap A2 is formed by shorter sides having a length d2 and longer sides having a length d3. Herein, the length d2 of the shorter sides is less than 1 mm, but the length d3 of the longer sides may be 1 mm or more. In other words, the length of the broader width is not a problem so long as the narrower width remains less than 1 mm.

The gap A3 is a rectangular opening through which wiring 29 is taken out. FIG. 3(b) shows a cross section of the subenclosure 18 having the gap A3. The coating of the wiring 29 which is taken out through the gap A3 is formed of a flame-retardant material, and passes at positions which are d4 and d5, respectively, distant from the opposing longer sides of the gap A3. Although each of d4 and d5 is less than 1 mm, (d4+d5) may be 1 mm or more. In other words, the length of the shorter sides of the opening of the gap A3 may be 1 mm or more. This means that “enclosing” is regarded as being established so long as each of the distances between the opposing coating faces (of flame-retardant material) of the wiring 29 and the longer sides of the flame-retardant material of the gap A3 (i.e., each of d4 and d5) is less than 1 mm. Herein, d4 and d5 are to be treated similarly to the aforementioned shorter sides d2 of the gap A2.

Therefore, so long as the shortest portion of a gap has a length of less than 1 mm, the internal electric circuitry may be regarded as being enclosed, despite the opening. The gap may be opened where the flame-retardant members are abutted together, or it may be a gap or aperture penetrating through a portion of flame-retardant member(s). It may be opened in an elliptical shape, in which case the gap may span a length of 1 mm or more so long as the narrower interspace of the opening is less than 1 mm.

As for the number of throughholes, too, FIG. 2 is only exemplary, and does not limit the present invention. Moreover, in FIG. 2, there is a total of four power IN/OUT terminals 28, including monitor terminals in addition to a positive electrode and a negative electrode. However, the construction may be adapted to other purposes, and the number of terminals is not limited to four.

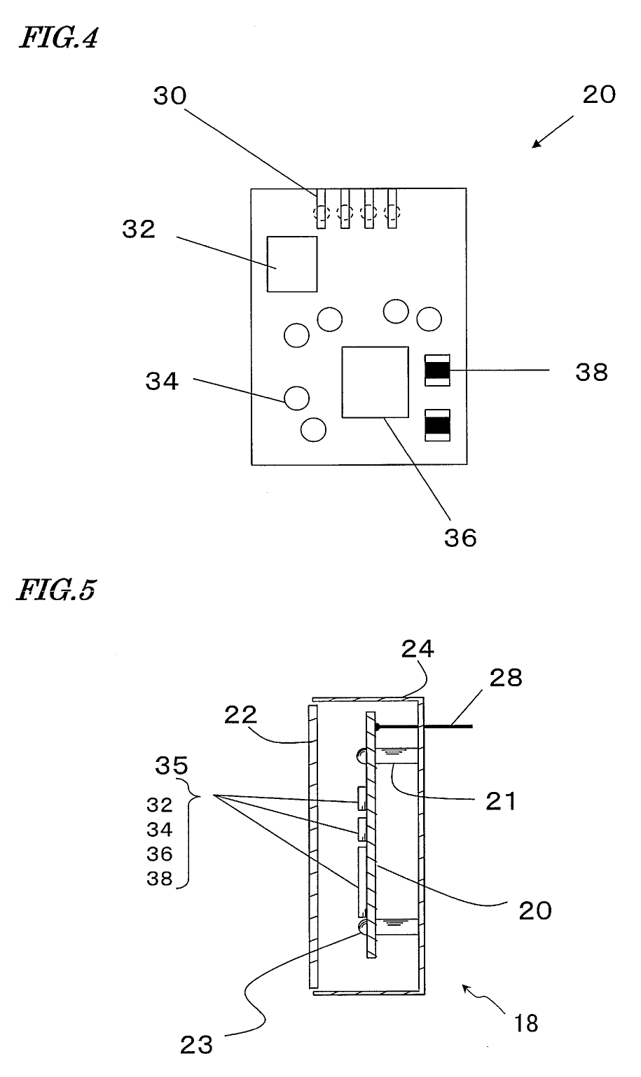

FIG. 4 shows a printed circuit board 20 to be enclosed by the subenclosure 18. The subenclosure 18 is meant for prevention of ignition of dust or the like, caused by heating of the circuitry, and electrification. Therefore, electric circuitry which handles a large electric power is to be mounted on the printed circuit board 20 which is enclosed by the subenclosure 18.

The printed circuit board 20 shown in FIG. 4 mainly includes a power control IC 36, a choke coil 34, and a capacitor 38. It is often the case that the printed circuit board 20 is a so-called power supplying printed circuit board, the printed circuit board 20 supplying voltages or currents to various parts of the camera. Hence, such component parts are to be mounted for boosting or driving of large electric currents.

Moreover, just as many cameras in the recent years are equipped with flashlights, the camera 1 may also be provided with a flashlight. In that case, a flash circuit 32 for generating flashlight would also be included in the electric circuitry. Since the flashlight uses a voltage which is boosted to about 300 V, it is necessary to prevent electrification of the user.

As a guide, the electric power to be handled by the printed circuit board which is enclosed by the subenclosure 18 is preferably 3 VA (=3 watts) or more. As a guide, the voltage is preferably 100 V (volts) or more.

It is particularly preferable to provide a subenclosure for any printed circuit board that handles an electric power of 15 watts or more. The reason for enclosing electric circuitry within a subenclosure is to prevent ignition and combustion due to the Joule heat caused by powering and to prevent electrification of the user. Therefore, it is unnecessary to enclose any electric circuitry that has a low power consumption. In circuit designing, power consumption is prescribed to be low in the wiring for currents and in the circuit elements; however, the power consumption may increase due to deterioration of the component parts and adhesion of dust. As a guide, 1A is considered to be the amount of current which will result in ignition under these cases. Usually, a digital camera is designed so as to operate with two or more AA batteries. This means that enclosing in a subenclosure is preferable in the case of handling an electric power or 3 VA or more.

Moreover, in order to allow a flashlight to emit light, it is necessary to charge it with a voltage of 100 V or more. Therefore, it is also preferable to enclose any circuit that handles a voltage of 100 V or more within the subenclosure 18.

Note that the power supply circuit and the flash circuit do not need to be present on a single printed circuit board. In other words, the subenclosure 18 may enclose a plurality of printed circuit boards.

The printed circuit board 20 has power IN/OUT terminal electrodes 30 provided thereon. The power IN/OUT terminal electrodes 30 are in electrical conduction with the power IN/OUT terminals 28, and serve as bases via which an electric power is supplied to the circuitry on the printed circuit board 20. In FIG. 4, the power IN/OUT terminals 28 are indicated with dotted circles. This indicates that the power IN/OUT terminals 28 are present on the rear side of the plane of the figure.

FIG. 5 shows a cross section of the subenclosure 18. The printed circuit board 20 has apertures for fixation purposes penetrating therethrough, and is fixed with screws 23 to bosses 21 which are provided on the flame-retardant member 24.

Circuits 35 are disposed on the printed circuit board 20. The circuits 35 include various circuits 32, 34, 36, and 38, and may include electrical devices as well. Although the circuits 35 are disposed on only one of the faces of the printed circuit board 20 in the figure, the circuits may also be constructed on the other face in the case where a multi-layered board is employed.

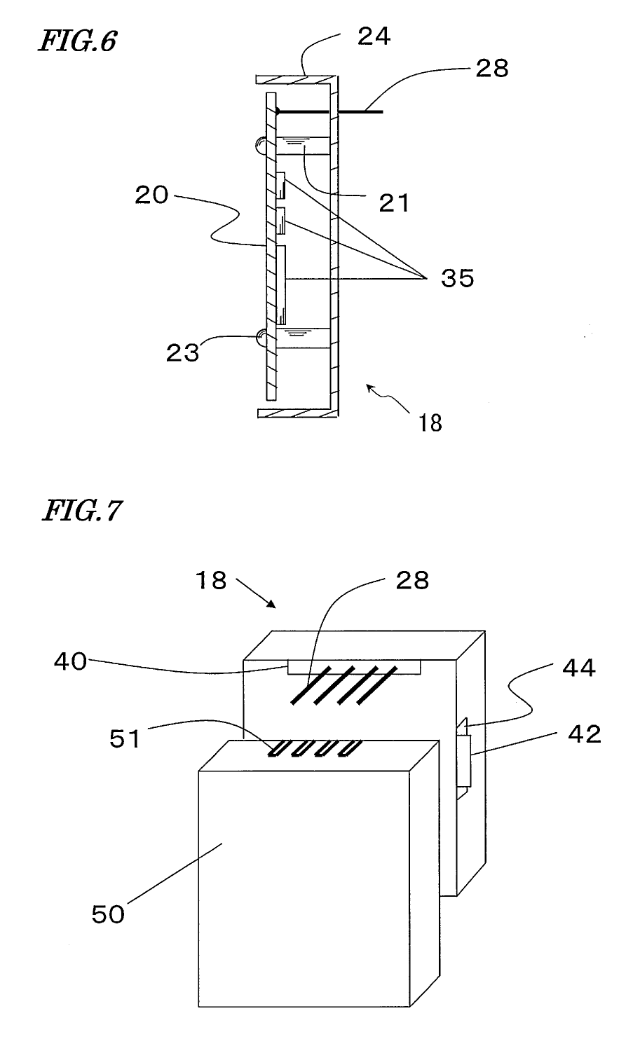

FIG. 6 shows an example where one face of the printed circuit board 20 on which no circuitry exists constitutes part of the subenclosure 18. Those elements which have identical counterparts in FIG. 5 are denoted by the same numerals.

Since the printed circuit board 20 is composed of a resin such as epoxy, if a flame retarder is mixed during its formation, the face (rear face) opposite to the face of the printed circuit board 20 on which the circuits 35 are provided can be regarded as one of the faces that compose the subenclosure 18. In other words, circuits 35 which utilize a large electric power may be constructed on one face of the printed circuit board 20, while the other face may constitute part of the subenclosure 18.

The objective of the present invention can be attained also by such a construction. As compared to the example of FIG. 5, the number of flame-retardant members can be reduced, and therefore space savings are realized. Thus, the flame-retardant members composing the subenclosure 18 do not need to be members for enclosing only, but may also be portions of other component parts.

In the example shown in FIG. 6, the rear face of the printed circuit board 20 already composes part of the subenclosure 18. Therefore, since the flame-retardant member 24 is disposed so as to cover the entire printed circuit board 20, a subenclosure 18 that encloses the printed circuit board 20 is formed.

Note that it is not indispensable to cover the entire printed circuit board 20. As in the examples of FIGS. 15(a) and (b) described later, for a portion of the electric circuitry that handles an electric power of 15 watts or more, a subenclosure that covers such electric circuitry may be provided.

FIG. 7 shows interconnections between the subenclosure 18 and a battery pack 50, which is a power supplying source. As shown in FIG. 1, the battery box 16 is provided in the housing 12. The battery pack 50 is inserted into the battery box 16 from a lower direction of the housing 12. In FIG. 7, the battery box 16 is omitted from illustration.

At an upper end of the battery pack 50, slits 51 in which connection electrodes (not shown) are exposed are provided. At an upper end of the battery box 16, the power IN/OUT terminals 28 which are taken out from the subenclosure 18 are disposed. Therefore, by allowing the connection electrode within the slits 51 of the battery pack 50 which has been inserted from the underside of the housing 12 to come in contact with the power IN/OUT terminals 28, electrical coupling is completed between the battery pack 50 and the printed circuit board 20 within the subenclosure 18.

Note that, concerning the manners of taking out the terminals and wiring from the subenclosure 18, FIG. 7 also shows examples other than those of FIGS. 3 to 6.

Specifically, the power IN/OUT terminals 28 may be taken out through a gap 40. Moreover, via a gap 44, a wiring board 42 for supplying electric power to another board may be taken out from the subenclosure 18. Note that the narrower width of these gaps must be less than about 1 mm.

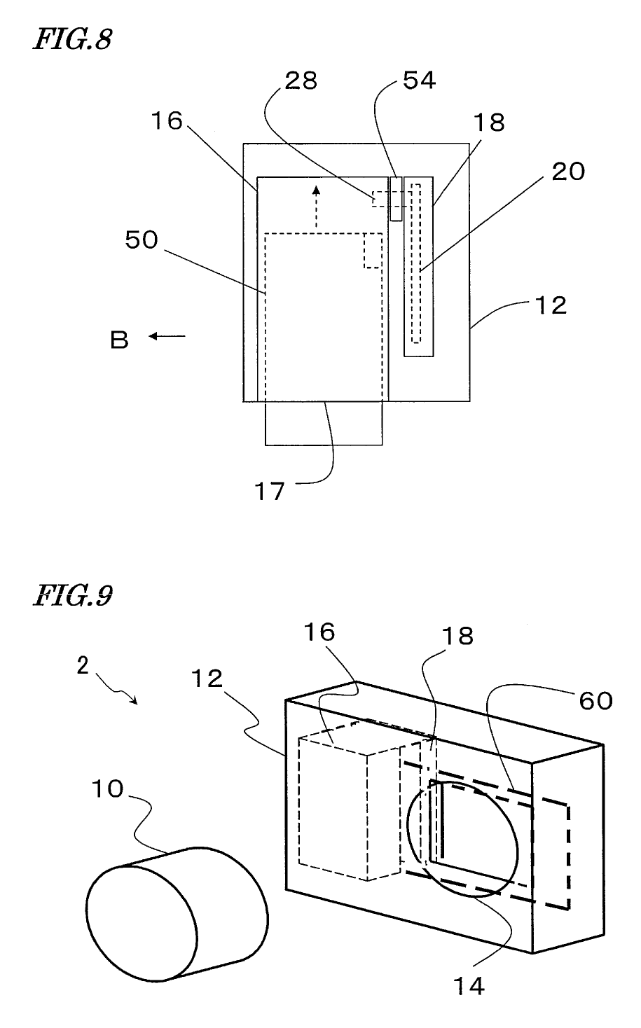

FIG. 8 shows relative positioning of the battery box 16, the battery pack 50, and the subenclosure 18 within the housing 12. Direction B is the direction in which the lens 10 to be attached to the camera 1 exists, and the direction along which the front face of the camera 1 opposes the lens 10.

In the housing 12, the subenclosure 18 and the battery box 16 are provided. The battery box 16 is formed as a part of the housing 12. A face 17 at which the battery pack 50 is to be inserted is open. That is, as viewed from the face 17 at which the battery pack 50 is to be inserted, the battery box 16 is a hole in the housing 12. Therefore, the interior of the battery box 16 is an outer surface of the housing 12.

The power IN/OUT terminals 28 which are taken out from the subenclosure 18 are disposed at an upper end of the interior of the battery box 16. The battery pack 50 is inserted into the battery box 16 from below, and the connection electrodes in the slits 51 come in contact with the power IN/OUT terminals 28. In the figure, a dotted arrow indicates the direction in which the battery pack 50 is inserted.

Therefore, in effect, the contact points between the battery pack 50 and the power IN/OUT terminals 28 exist outside the housing 12.

When the battery box 16 and the battery pack 50 are constructed from flame-retardant members, the contact points are enclosed by the slits 51 (FIG. 7) and the inner walls of the battery box 16, thus preventing ignition due to straying foreign bodies and electrification.

It is likely that a large electric current is flowed through the power IN/OUT terminals 28. Therefore, the subenclosure 18 and the power IN/OUT terminals 28 of the battery box 16 are enclosed by a terminal cover 54. The terminal cover 54 is also composed of a flame-retardant member.

With such a construction, intrusion of foreign bodies into the subenclosure 18 is further suppressed.

### Embodiment 2

FIG. 9 schematically shows the exterior appearance of an interchangeable lens type camera 2 (hereinafter referred to as the “camera 2”) according to the present embodiment.

The present embodiment illustrates a case where the subenclosure 18 is constructed as portions of other component parts. In the housing 12, an aluminum frame 60 for improving the strength is built. The aluminum frame 60 doubles as part of the battery box 16, and also doubles as part of the subenclosure 18. Moreover, some of the faces of the battery box 16 are extended to compose a part of the subenclosure 18. In other words, the subenclosure 18 according to the present embodiment includes portions of the aluminum frame 60 and the battery box 16.

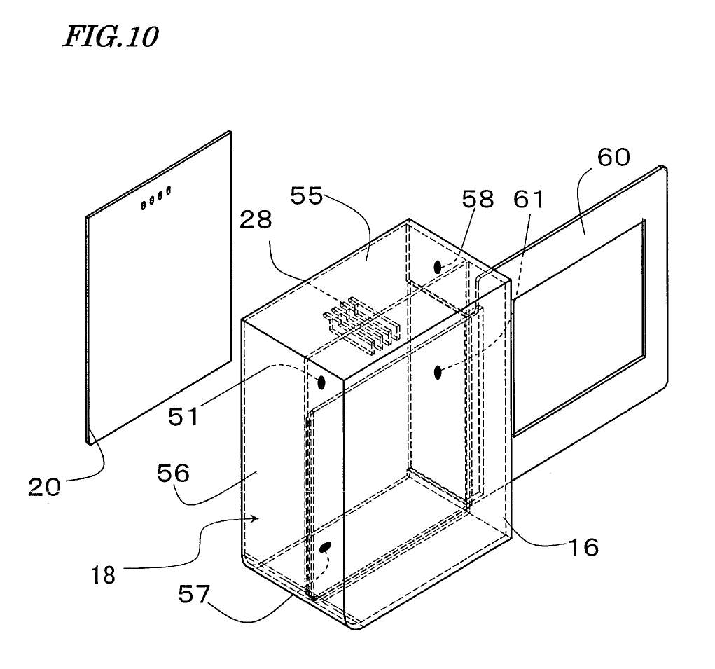

FIG. 10 shows relative positioning between the aluminum frame 60, the battery box 16, and the printed circuit board 20. The aluminum frame 60 is opened in the form of a window where an imaging unit is to be installed. One end thereof is extended in the form of a surface which composes substantially one face of the battery box 16.

Moreover, the upper, lower, and left faces of the battery box 16 are extended to serve respectively as an upper skirt 55 of the battery box 16, a lower skirt 57 of the battery box 16, and a side skirt 56 of the battery box 16.

A side skirt 58 on the side where the aluminum frame 60 is to be fitted (right-hand side) is cut off by a length along the height direction of the portion of the aluminum frame 60 that doubles as part of the battery box 16. After the aluminum frame 60 is fitted, the side skirt 58 is covered by a side cover 61.

The power IN/OUT terminals 28 are provided at the upper portion of the battery box 16. The printed circuit board 20 is connected to the power IN/OUT terminals 28.

The housing portion (not shown) of the camera 2 is to be disposed at the rear side of the printed circuit board 20.

That is, the printed circuit board 20 is enclosed by the aluminum frame 60 constituting substantially one face of the battery box 16, a rear face 51 of the battery box 16, the upper skirt 55 of the battery box 16, the lower skirt 57 of the battery box 16, the side skirts 56 and 58 of the battery box 16, the side cover 61, and the rear face of the housing 12. By composing each of these members from a flame-retardant material, the printed circuit board 20 becomes enclosed by flame-retardant members. Stated otherwise, the subenclosure 18 is composed by a portion each of the aluminum frame 60, the battery box 16, and the housing 12.

Note that the rear face 51 of the battery box 16 may be present not only at the upper portion but also the lower portion of the aluminum frame 60.

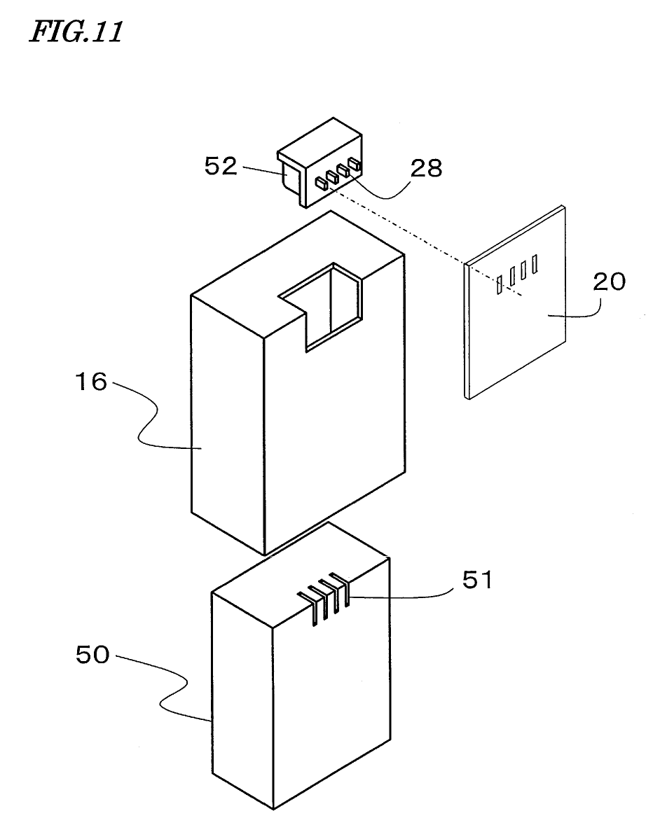

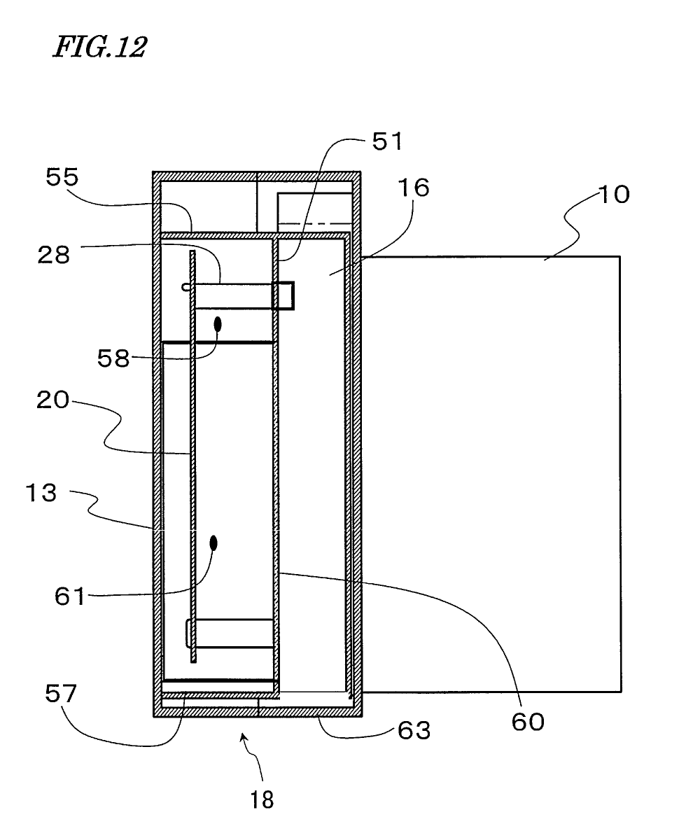

FIG. 11 more clearly shows the relationship between the battery box 16, the battery pack 50, and the printed circuit board 20 of FIG. 10. Note that, the upper and lower skirts 55 and 57, the side skirts 56 and 58, and the like of the battery box 16 are omitted from FIG. 11.

When the battery pack 50 is inserted from the underside of the battery box 16, and the power IN/OUT terminals 28 come into contact with the terminal electrodes within the slits 51, the printed circuit board 20 enters a conducting state. The power IN/OUT terminals 28 are attached to an upper portion of the battery box 16 via a terminal cover 52. In other words, the terminal cover 52 separates the portions, of the power IN/OUT terminals 28, that lie inside the battery box 16 from the portions that lie outside.

With such a construction, it becomes possible to solder the printed circuit board 20 to the power IN/OUT terminals 28 in advance, and attach them to the battery box 16.

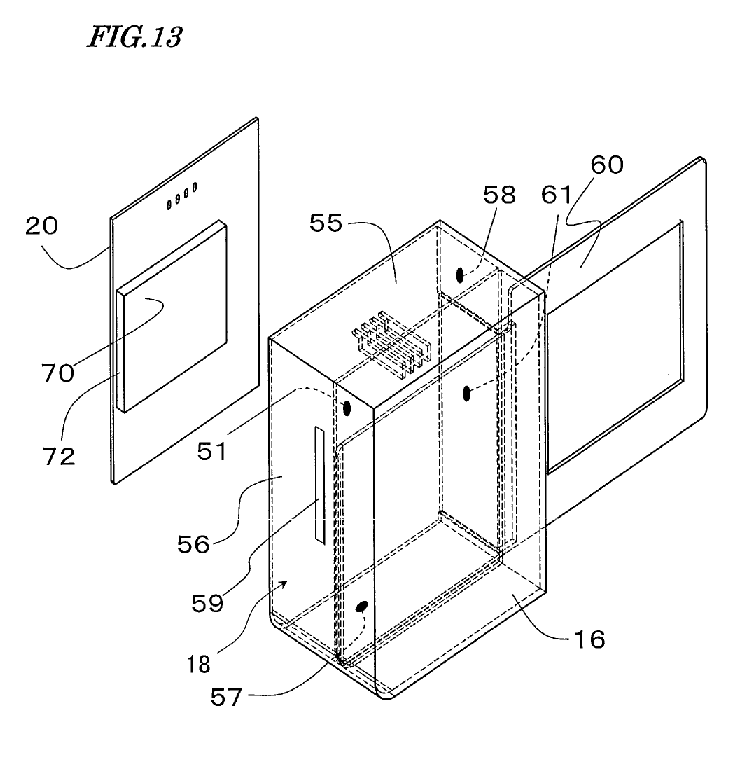

FIG. 12 is a side cross-sectional view of the subenclosure 18 shown in FIG. 10. FIG. 12 corresponds to a view in the direction that the aluminum frame 60 exists, as seen from the side face labeled with reference numeral 56 in FIG. 10.

The printed circuit board 20 is enclosed by the aluminum frame 60, the housing rear face 13, the upper skirt 55 and lower skirt 57 of the battery box 16, the side cover 61, and the side skirt 58. Note that the face which should lie in the front side of the paper sheet in FIG. 10 (corresponding to the left-hand side of the subenclosure 18) is bounded by the side skirt 56 of the battery box 16.

Although the lower face of the battery box 16 is left open for battery insertion, the figure shows a lid 63 being attached to the housing 12. When a battery is inserted into the battery box 16, the electric power from the battery is supplied to the printed circuit board 20 via the power IN/OUT terminals 28.

As is described in the present embodiment, the subenclosure 18 may be composed of portions of other component parts inside the camera 2, so long as the electric circuitry that handles a large electric power is enclosed by flame-retardant members.

### Embodiment 3

FIG. 13 shows a construction in which a memory holder 70 is disposed between the printed circuit board 20 and the aluminum frame 60. The memory holder 70 has a slot 72 for memory insertion, and a corresponding aperture 59 for the memory insertion is formed in the side skirt 56 of the battery box. Although not shown, a corresponding aperture is also provided in a side face of the housing.

Most digital cameras have a function of recording image data to not only an internal memory but also an external memory. In doing this, the memory holder 70 serves as an interface with the external memory. There is no particular limitation as to the external memory, e.g., a semiconductor memory, an optical disk, a magnetic disk.

A relatively large electric power is likely to be used for performing a write, a read, or driving for an external memory, and thus it is preferably disposed near a printed circuit board 20 which is the power supplying source. In other words, it may preferably be positioned in the interior of the subenclosure 18 in some cases.

Moreover, the memory holder 70 has a slot 72 which is open to the exterior of the housing for allowing a memory to be inserted from outside of the housing. Therefore, dust may stray in through the slot 72.

Therefore, in the present embodiment, in addition to the side skirt 56 and the like shown in Embodiment 2, the memory holder 70 also serves as an element constituting the subenclosure. In other words, the memory holder 70 is also composed of a flame-retardant member.

The memory holder 70 becomes a high-frequency signal generating source for realizing a high transfer rate. Therefore, the memory holder 70 is preferably composed of an electrically conductive metal that is a flame-retardant member.

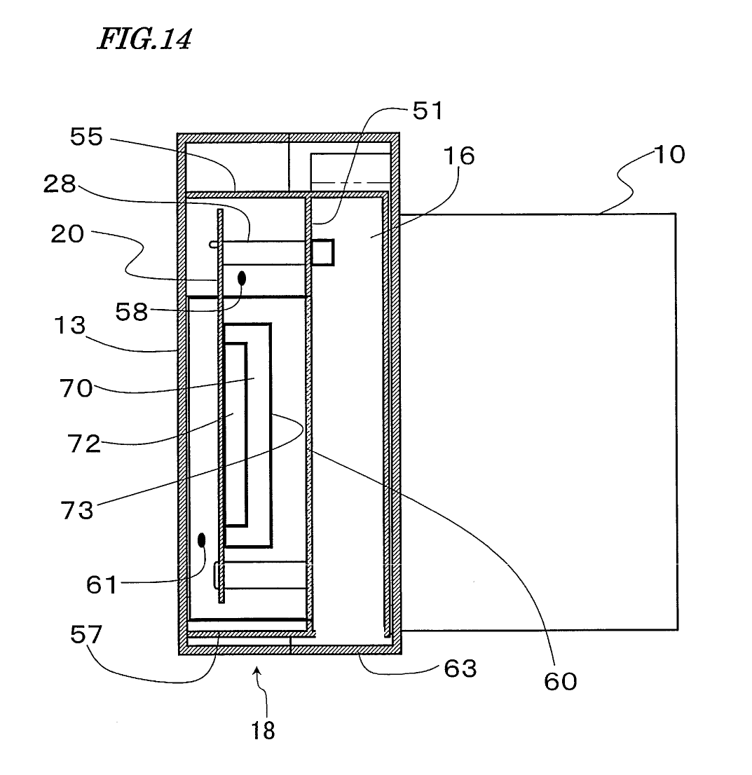

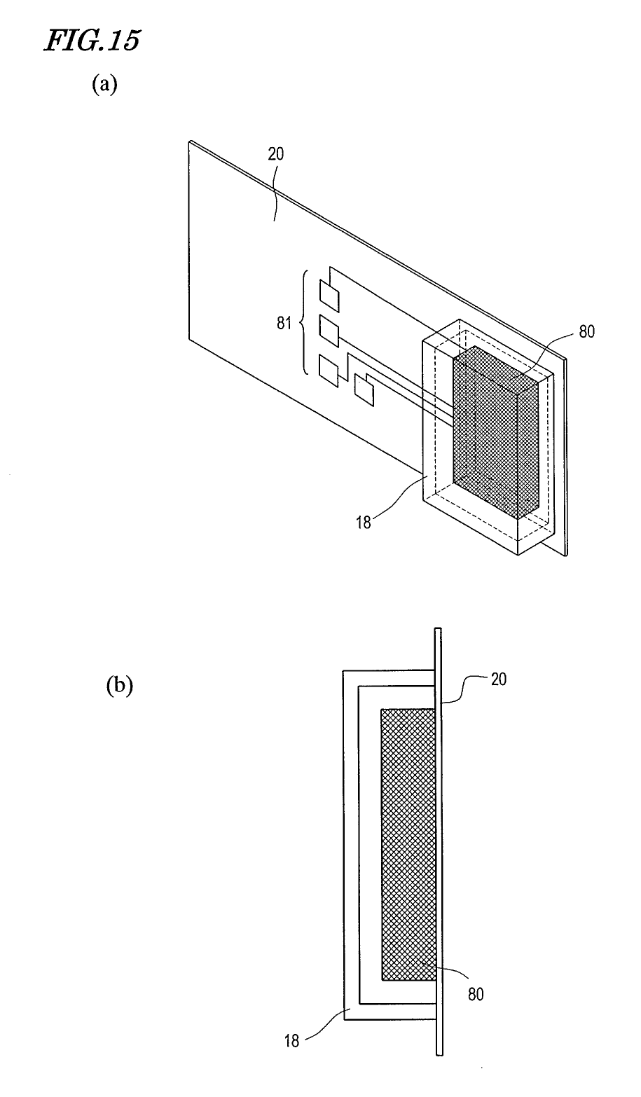

FIG. 14 is a side cross-sectional view of the subenclosure 18 having the memory holder 70. The memory holder 70 is directly attached to the printed circuit board 20. In other words, a conductive metal portion 73 of the memory holder 70 is placed in close contact with the printed circuit board 20. Furthermore, a portion of the printed circuit board 20 doubles as a face of the memory holder 70.

Moreover, the slot 72 of the memory holder 70 is disposed close to the aperture 59 on the outside of the housing. Therefore, although the subenclosure 18 has the aperture 59 opened in a portion of the side skirt 56 of the battery box 16, the printed circuit board 20 is enclosed by flame-retardant members. Specifically, the region of the printed circuit board 20 that constitutes a portion of the memory holder 70 is not included in the printed circuit board that is enclosed by the subenclosure 18.

Note that, by providing a door which is capable of opening/closing (not shown) on the aperture 59 for memory insertion that is formed on the housing, it becomes possible to also enclose the interior of the memory holder 70 by flame-retardant members. That is, if any circuit or electrical device that handles a large electric power is present within the memory holder 70, with respect to such a circuit or electrical device, a subenclosure is constructed by the electrically conductive metal 73, the printed circuit board 20 composed of a flame-retardant member, and the door capable of opening/closing.

Thus, embodiments of the present invention have been described.

In the above-described embodiments, the printed circuit board 20 is illustrated as being entirely enclosed by the subenclosure 18. However, it is not necessary that the entire printed circuit board 20 is enclosed.

FIG. 15(a) shows circuitry 80 on a portion of the printed circuit board 20 that is enclosed by the subenclosure 18, and FIG. 15(b) is a cross-sectional view thereof. The circuitry 80 has a power consumption of 15 watts or more, whereas the other circuitry (e.g., circuits 81) has a power consumption of less than 15 watts. Since only the circuitry whose power consumption is equal to or greater than the reference level of 15 watts is enclosed by the subenclosure 18, heating and/or electrical leakage due to dust or the like, and electrification of the user can be prevented.

Although FIG. 15 only shows a single circuit 80, this is exemplary. The circuit 80 may include one or more groups of circuits, wiring, devices, and the like.

According to the present invention, if dust strays into an interchangeable lens type camera and ignition unfortunately occurs due to heating and/or electrical leakage of the electric circuitry, the fire will be extinguished within the case interior so as not permit spread of fire. Thus, an interchangeable lens type camera which is assuredly safe to use can be obtained.

What is claimed is:

1. A camera comprising:
a case having a mount section for mounting a detachable lens;
electric circuitry provided within the case; and
a member covering at least a portion of the electric circuitry to prevent the electric circuitry from being exposed to the exterior when the lens is detached from the mount section.

2. The camera of claim 1, wherein the member is composed of a flame-retardant material.

3. The camera of claim 2, wherein the electric circuitry is enclosed by the member.

4. The camera of claim 2, wherein the electric circuitry is provided on a board which is composed of a flame-retardant material, and the electric circuitry is covered by the member.

5. The camera of claim 2, wherein,
the electric circuitry includes a plurality of circuits; and
at least one first circuit among the plurality of circuits is covered by the member, and at least one second circuit among the plurality of circuits is not covered by the member.

6. The camera of claim 5, wherein the plurality of circuits are classified into either the first circuit or the second circuit depending on a level of used voltage or consumed electric power.

7. The camera of claim 2, wherein the electric circuitry is a power supply circuit.

8. The camera of claim 2, wherein,
the electric circuitry includes a booster circuit for generating flashlight; and
the booster circuit is enclosed by the member.

9. The camera of claim 2, wherein the electric circuitry is enclosed by a plurality of said members.

10. The camera of claim 2, wherein the electric circuitry consuming an electric power of 15 watts or more is enclosed by the member.

11. The camera of claim 2, further comprising a component, at least one portion of outer surface thereof is composed of a flame-retardant material, wherein,
the at least one portion of the outer surface covers at least a portion of the electric circuitry.

12. The camera of claim 2, further comprising a battery box for accommodating a battery, the battery box having a first terminal for allowing electric power from the battery to be supplied to the exterior of the battery box, wherein,
a second terminal which is in electrical connection with the electric circuitry is provided on the member covering at least a portion of the electric circuitry, the second terminal being in contact with the first terminal.

13. A camera comprising:
a case having a mount section for mounting a detachable lens;
electric circuitry provided within the case; and
a member enclosing at least a portion of the electric circuitry, the member being composed of a flame-retardant material.
